(19) United States
(12) Patent Application Publication
(10) Pub. No.: US 2016/0169662 A1
(43) Pub. Date: Jun. 16, 2016

(54) LOCATION-BASED FACILITY MANAGEMENT SYSTEM USING MOBILE DEVICE

(71) Applicant: V & I Co., Ltd., Goyang-Si (KR)

(72) Inventors: Hyuk Kyu Lim, Goyang-Si (KR); Young Seop Kim, Seoul (KR)

(21) Appl. No.: 14/613,613

(22) Filed: Feb. 4, 2015

(30) Foreign Application Priority Data
Dec. 10, 2014 (KR) 10-2014-0177294

(51) Int. Cl. G01B 11/14; G06T 7/00; H04N 5/44; G06F 17/30; G06T 19/00

(52) U.S. Cl. CPC G01B 11/14; G06F 17/30247; G06F 17/30876; G06T 19/006; H04N 5/44; G06T 7/004

(57) ABSTRACT

A location-based facility management system includes a database server configured to store object information on a management target facility acquired in advance as a database, an image acquisition module configured to acquire an object image and GPS information, an auto calibration module provided with an auto calibration algorithm which decides an internal parameter for the image, a DB input/output module configured to store the object information in the database server and to receive the object information from the database server, a position correction module provided with a position correction algorithm which corrects the GPS information of the object image using the internal parameter decided by the auto calibration module and the object information received from the DB input/output module, and a mobile device provided with a facility management application which detects a characterizing point of an object image acquired by a camera.

### FIELD OF THE INVENTION

The present invention relates to a facility management system for informing positions of various kinds of facilities existing on roads or industrial sites. More particularly, the present invention pertains to a location-based facility management system using a mobile device which can manage management target facilities on a real time basis regardless of locations by detecting a characterizing point of an object image obtained by a camera of a mobile device and applying an augmented reality correction technique.

### BACKGROUND OF THE INVENTION

In recent years, an augmented reality (AR) technique is utilized in many different fields along with the popularization of mobile devices such as a smartphone and the like. The augmented reality technique refers to a technique which overlaps a virtual object with a real world seen in the eyes of a user. The augmented reality technique is also referred to as a mixed reality (MR) technique, because the augmented reality technique shows one image by merging a real world with a virtual world.

According to the augmented reality technique, it is possible to visually superimpose different kinds of additional information (e.g., a graphical element indicating a point of interest) on an image containing a real world actually viewed by a user. That is to say, the augmented reality makes use of a virtual environment created by computer graphic. However, the majority of the augmented reality is a real environment. The computer graphic serves to additionally provide information required in the real environment.

When the augmented reality technique is used, a three-dimensional virtual image is superimposed on a real image viewed by a user. Thus, the demarcation between the real environment and the virtual image becomes ambiguous.

For example, if the surroundings are scanned by a camera of a mobile device such as a smartphone or the like, information such as the positions of buildings, the distance between buildings and telephone numbers are displayed on the screen of the mobile device.

Unlike the virtual reality technique which draws a user's attention to the virtual reality and prevents a user from seeing the real environment, the augmented reality technique for merging the real environment with the virtual object enables a user to see the real environment. Thus, the augmented reality technique has an advantage in that it can provide different kinds of additional information together with the real environment.

According to the augmented reality technique, an augmented reality marker is detected from an image captured by a camera. A three-dimensional virtual object corresponding to the detected marker can be synthesized with the image and can be outputted together with the image. This makes it possible to visualize a virtual character on an image as if the virtual character exists in reality.

In order to have a virtual object appear on a real image, markers need to be recognized on a frame-by-frame basis. The size, position and shape of the virtual object need to be calculated so as to correspond to the kinds and positions of the markers. At the position thus calculated, the virtual object needs to be synthesized with the image.

However, in case of an augmented reality contents output system of marker type, there is a problem in that it is difficult to clearly recognize a marker on an image. That is to say, if the marker is positioned far away, it is impossible for a camera to recognize the marker. This makes it difficult to display a virtual object, i.e., an augmented reality object, on a screen.

As one of solutions to this problem, there is available a method in which a virtual object is mapped on the positional information of a GPS instead of a marker, thereby displaying a mapped augmented reality object near a current position based on only the positional information of a terminal.

However, the mapping method has a shortcoming in that it is only possible to know the x and y coordinate information of a relevant position based on the GPS position information and it is impossible to know the height information of the relevant position.

For that reason, the augmented reality technique using a GPS suffers from a problem in that, depending on the position of a terminal, an object is displayed as if it is floating in the sky or positioned below a ground surface.

Furthermore, there is a problem in that the GPS position information used in a small mobile device such as a smartphone or the like is inaccurate because a positional error of about 50 m is generated due to the error of a GPS sensor.

Moreover, in case of camera calibration which is an essential element of augmented reality, the camera calibration is performed by an autofocus method differing from mobile device to mobile device. Thus an error exists in an internal parameter value. This makes it difficult to confirm the position of a facility installed in an open terrain and to manage the state of a facility on a real time basis.

### SUMMARY OF THE INVENTION

In view of the aforementioned problems inherent in the prior art, it is an object of the present invention to provide a facility management system capable of automatically extracting a characterizing point based on only an image obtained through a camera of a mobile device and capable of improving the accuracy of measurement of a distance between a mobile device and a target object.

Another object of the present invention is to provide a facility management system capable of correcting an error rate of an internal parameter value through the use of an auto calibration technique, thereby improving the accuracy of augmented reality matching, avoiding occurrence of an error and enhancing the performance of the system.

A further object of the present invention is to provide a facility management system capable of managing a facility through the use of a GPS-information-based augmented reality service which employs a camera calibration position information technique and an augmented-reality-platform-based core technique.

A still further object of the present invention is to provide a facility management system capable of finding the position of a facility installed on a road or an industrial site through the use of a GPS-information-based augmented reality service, managing the history data of the facility thus found, monitoring the current operation state of the facility and managing the facility on a real time basis.

A location-based facility management system using a mobile device according to the present invention includes: a database server configured to store object information on a management target facility acquired in advance as a database; an image acquisition module configured to acquire an object image and GPS information; an auto calibration module provided with an auto calibration algorithm which decides an internal parameter for the image; a DB input/output module configured to store the object information in the database server and to receive the object information from the database server; a position correction module provided with a position correction algorithm which corrects the GPS information of the object image using the internal parameter decided by the auto calibration module and the object information received from the DB input/output module; and a mobile device provided with a facility management application which detects a characterizing point of an object image acquired by a camera after deciding an internal parameter of the object image and performs history management for the management target facility by matching the characterizing point with the object information stored in the database server.

In the location-based facility management system, the database server may be configured to store, as stored data, the object image of the management target facility, the object GPS information, and the basic object information including actual object measurement data and history data of the management target facility and may be configured to store, as generated data, the information on the characterizing point of the object image detected by the facility management application of the mobile device.

In the location-based facility management system, the facility management application may be configured to match the characterizing point of the object image acquired by the camera of the mobile device with the characterizing point of the object image received from the database server and then to find the relative position of the mobile device with respect to the object using a stereo image method.

According to the location-based facility management system using a mobile device, it is possible to automatically extract a characterizing point based on only an image obtained through a camera of a mobile device and to match the characterizing point with an object image of a database server. It is also possible to correct an error rate of an internal parameter value through the use of an auto calibration technique and to rapidly find the position of a facility to be managed.

Furthermore, according to the location-based facility management system using a mobile device, it is possible to manage the history data of a facility to be managed, monitor the operation state of the facility and manage the facility on a real time basis.

Furthermore, according to the location-based facility management system using a mobile device, it is possible to confirm the position of a facility through the use of a mobile device regardless of the location and to manage the operation state of the facility on a real time basis.

Furthermore, according to the location-based facility management system using a mobile device, it is possible to manage a facility through the use of a GPS-information-based augmented reality service which employs a camera calibration position information technique and an augmented-reality-platform-based core technique.

### BRIEF DESCRIPTION OF THE DRAWINGS

The above and other objects and features of the present invention will become apparent from the following description of preferred embodiments, given in conjunction with the accompanying drawings.

FIG. 1 is a conceptual diagram schematically showing a location-based facility management system according to the present invention.

FIG. 2 is a reference view for explaining an auto calibration algorithm which constitutes a major part of the present invention.

FIG. 3 is a flowchart schematically showing a position correction and characterizing point detection algorithm used in a facility management application which constitutes a major part of the present invention.

FIG. 4 is a reference view for explaining a calculation process of fundamental matrices and essential matrices in a facility management application which constitutes a major part of the present invention.

FIG. 5 is a reference view showing a main screen for facility management using a facility management application which constitutes a major part of the present invention.

FIG. 6 is a reference view showing a facility management screen using a facility management application which constitutes a major part of the present invention.

FIG. 7 is a screen of a mobile device showing the position information of a facility indicated on a map by a facility management application which constitutes a major part of the present invention.

FIG. 8 is a screen of a mobile device in which the position of a facility is indicated by a location-based augmented reality through the use of a facility management application which constitutes a major part of the present invention.

### DETAILED DESCRIPTION OF THE PREFERRED EMBODIMENTS

One preferred embodiment of a location-based facility management system using a mobile device according to the present invention will now be described in detail with reference to the accompanying drawings.

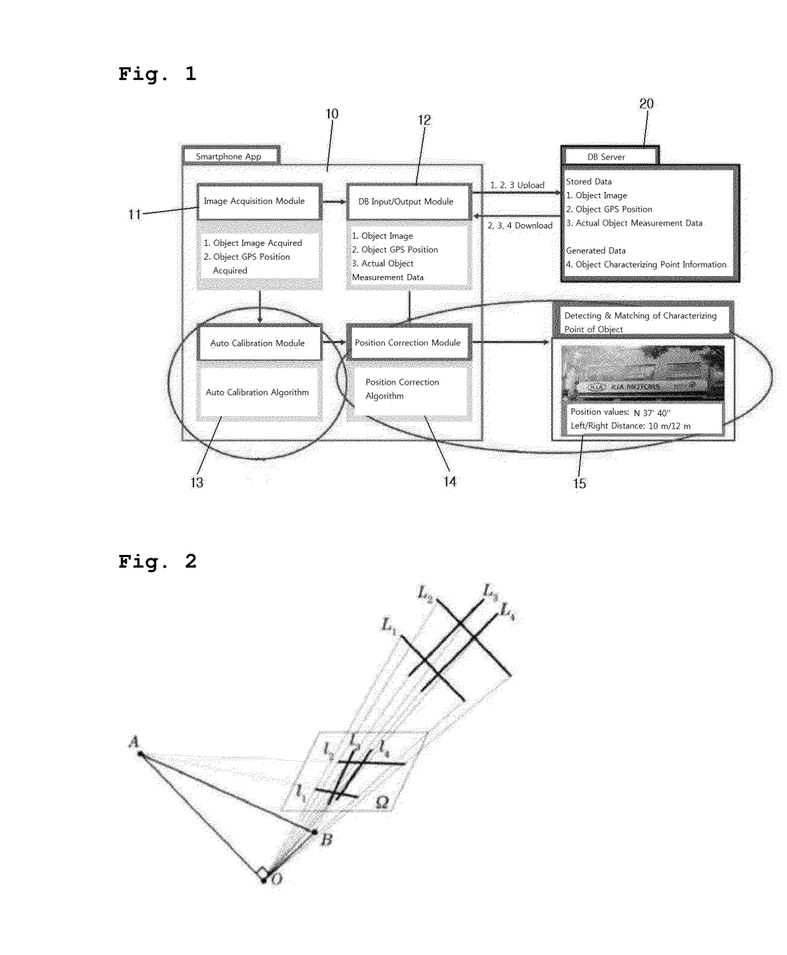

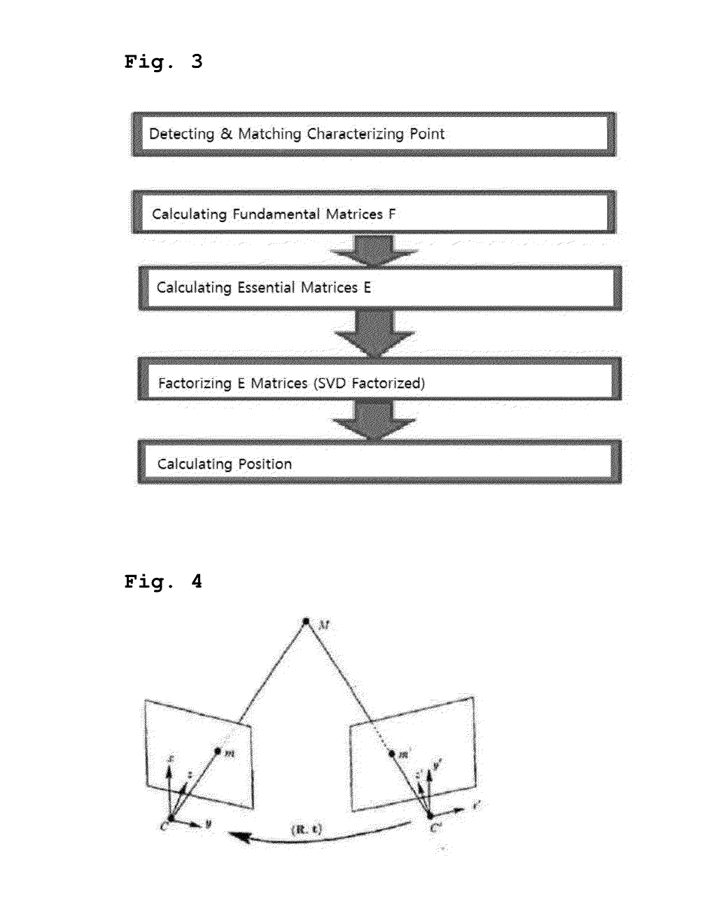

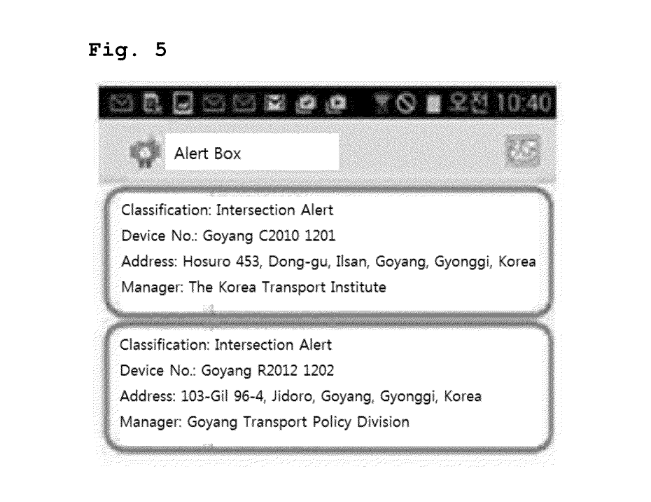

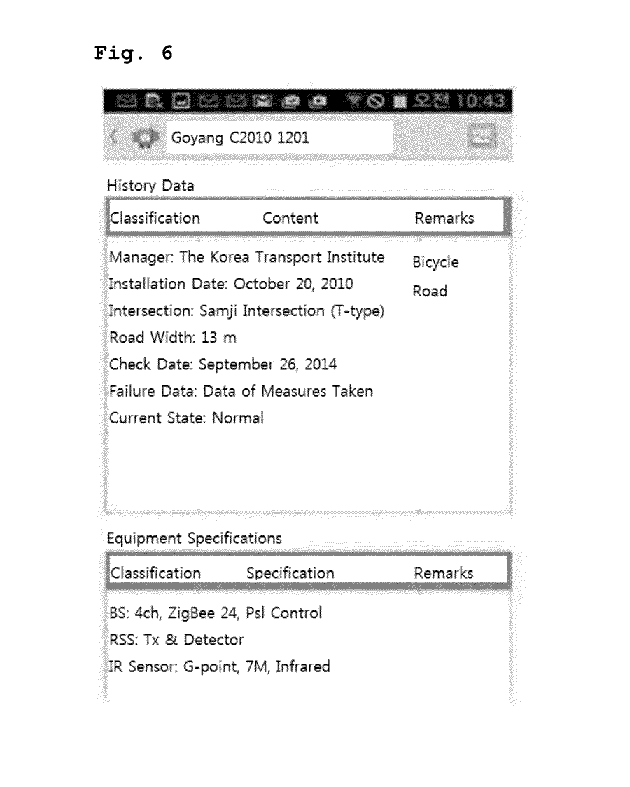

Referring to FIGS. 1 to 7, a location-based facility management system using a mobile device according to the present invention includes: a database server 20 configured to store object information on a management target facility acquired in advance as a database; an image acquisition module 11 configured to acquire an object image and GPS information; an auto calibration module 12 provided with an auto calibration algorithm which decides an internal parameter for the image; a DB input/output module 13 configured to store the object information in the database server 20 and to receive the object information from the database server 20; a position correction module 14 provided with a position correction algorithm which corrects the GPS information of the object image using the internal parameter decided by the auto calibration module 12 and the object information received from the DB input/output module 13; and a mobile device 10 provided with a facility management application 15 which detects a characterizing point of an object image acquired by a camera after deciding an internal parameter of the object image and performs history management for the management target facility by matching the characterizing point with the object information stored in the database server 20.

The auto calibration algorithm is configured to derive a value of the internal parameter using coordinates of vanishing points. That is to say, as shown in FIG. 2, if two pairs of straight lines L₁, L₂, L₃ and L₄ orthogonal to each other in a real world are projected on an image plane, the straight lines appear as l₁, l₂, l₃ and l₄ in a projected image. Two vanishing points A and B can be found from the straight lines appearing on the projected image.

If a starting point O (0,0,0) are joined to the vanishing points A and B in a three-dimensional camera coordinate system in which the center of a lens becomes the starting point, the respective straight lines have the relationship given by the following mathematical formula 1.

L₁//L₂, L₃//L₄, L₁⊥L₃

OA//L₁, OB//L₃, OA⊥OB

At this time, ΔOAB is a right-angled triangle. The camera coordinate system appears in the form of a sphere having a point O on the surface thereof and having a diameter of AB. The coordinates of the vanishing points A and B in an image coordinate system can be defined by the following mathematical formula 2.

$$A ( {u}_{A} , {v}_{A} ) , B ( {u}_{B} , {v}_{B} )$$

$${Z}_{c} ( \begin{matrix}u \\ v \\ 1\end{matrix} ) = [ \begin{matrix}f / {d}_{x} & 0 & {c}_{x} \\ 0 & f / {d}_{y} & {c}_{y} \\ 0 & 0 & 1\end{matrix} ] ( \begin{matrix}1000 \\ 0100 \\ 0010\end{matrix} ) ( \begin{matrix}{X}_{c} \\ {Y}_{c} \\ {Z}_{c} \\ 1\end{matrix} ) = [ \begin{matrix}f / {d}_{x} & 0 & {c}_{x} \\ 0 & f / {d}_{y} & {c}_{y} \\ 0 & 0 & 1\end{matrix} ]$$

In the mathematical formula 2, f is the focal distance, dₓ and d_{y} are the width and height of pixels of a camera sensor such as a CMOS or a CCD, and Cₓ and C_{y} are the projection coordinates of a starting point in the image coordinate system.

The coordinates of the vanishing points in the camera coordinate system are represented by the following mathematical formula 3.

A((u_{A}−cₓ)dₓ,(v_{A}−c_{y})d_{y},f),B((u_{B}−cₓ)dₓ,(v_{B}−c_{y})d_{y},f)

If the coordinates of the vanishing points are applied to an equation of a sphere whose diameter is equal to a segment AB and if the coordinates of the vanishing points are substituted with the starting point coordinates O (0,0,0), it is possible to obtain the following mathematical formula 4.

$${[ x - \frac{{u}_{A} + {u}_{B}}{2} {d}_{x} + {c}_{x} {d}_{x} ]}^{2} + {[ y - \frac{{v}_{A} + {v}_{B}}{2} {d}_{y} + {c}_{y} {d}_{y} ]}^{2} + {( z - f )}^{2} = {( \frac{{u}_{A} - {u}_{B}}{2} {d}_{x} )}^{2} + {( \frac{{v}_{A} - {v}_{B}}{2} {d}_{y} )}^{2}$$

$$\frac{( {c}_{x} - {u}_{A} ) ( {c}_{x} - {u}_{B} )}{{f}_{x}^{2}} + \frac{( {c}_{y} - {v}_{A} ) ( {c}_{y} - {v}_{B} )}{{f}_{y}^{2}} + 1 = 0$$

In the mathematical formula 4, all the internal parameters fₓ, f_{y}, cₓ and c_{y} are unknowns. At least four equations are required in order to know the internal parameters fₓ, f_{y}, cₓ and c_{y}. This means that four or more images are needed to find the coordinates of the vanishing points.

That is to say, four equations are obtained by applying the coordinates of the vanishing points u_{A}, u_{B}, v_{A} and v_{B} found from four images to the mathematical formula 4. By solving the four equations, it is possible to find the internal parameters fₓ, f_{y}, cₓ and c_{y}.

In the database server 20, the object image of the management target facility, the object GPS information, and the basic object information including actual object measurement data and history data of the management target facility are stored as stored data. Furthermore, the information on the characterizing point of the object detected by the facility management application 15 of the mobile device 10 is stored as generated data.

In the meantime, the facility management application 15 is configured to match the characterizing point of the object image acquired by the camera of the mobile device 10 with the characterizing point of the object image received from the database server 20. Thereafter, the facility management application 15 finds the relative position of the mobile device 10 with respect to the object using a stereo image method.

In the stereo image method, the characterizing points of the images taken by two cameras are matched to calculate the projection relationship F between the pixels of the two cameras (fundamental matrices). The vector relationship E between the pixels of the two cameras (essential matrices) is calculated using the matched characterizing points and the F matrices. Then, the relative rotation amount and the relative displacement of the two cameras are calculated by decomposing the E matrices.

Next, the stereo image method will be described in detail with reference to FIG. 4.

In general, the rotation matrices of a virtual camera are indicated by R and are defined by matrices having a 3×3 size. The matrix equation indicative of the displacement of the virtual camera is indicated by S and is defined by matrices having a 3×3 size.

The E matrices are indicated by the product of the rotation matrices R and the movement matrices S of the camera and are defined by an equation E=RS.

The F matrices are calculated by finding the relationship between two corresponding characterizing points m and m′ on the screens of two cameras. The calculation formula of the F matrices is defined by m^{T}Fm′=0 and can be given by the following mathematical formula 5.

xₜ^{T}Fxᵣ=0

At this time, it is theoretically possible to know the F matrices by finding eight corresponding characterizing points. The error becomes smaller as the number of the characterizing points used grows larger.

The E matrices can be obtained using the F matrices obtained by the mathematical formula 5. The E matrices are represented by the following mathematical formula 6.

E=Kₗ^{-T}FKᵣ

In the mathematical formula 6, Kₗ is the parameter of a left camera and Kᵣ is the parameter of a right camera.

Then, a SVD factor is found by factorizing the E matrices as represented by the following mathematical formula 7.

E=UDV^{T}

The relative rotation amount R and the relative displacement S of the two object images can be calculated by assuming the matrix values of X and Y to be represented by the following mathematical formula 8.

$$Y = ( \begin{matrix}0 & 1 & 0 \\ - 1 & 0 & 0 \\ 0 & 0 & 1\end{matrix} ) Z = ( \begin{matrix}0 & - 1 & 0 \\ 1 & 0 & 0 \\ 0 & 0 & 0\end{matrix} )$$

That is to say, the relative rotation amount R is indicated by UYV^{T} or UY^{T}V^{T} and the relative displacement S is indicated by VZV^{T}.

As a result, the accurate position of the management target facility can be grasped by performing position correction through the auto calibration for the object image acquired using the camera of the mobile device 10 and the GPS information of the object and by matching the object image acquired using the camera of the mobile device 10 with the object image of the database server 20.

The management target facility corresponding to the acquired object image can be confirmed on a real time basis. The history management for the respective facilities can be carried out.

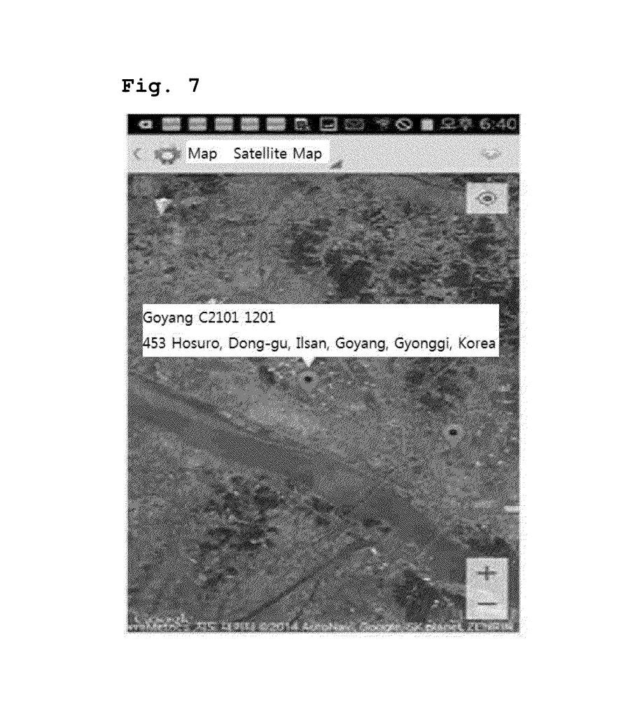

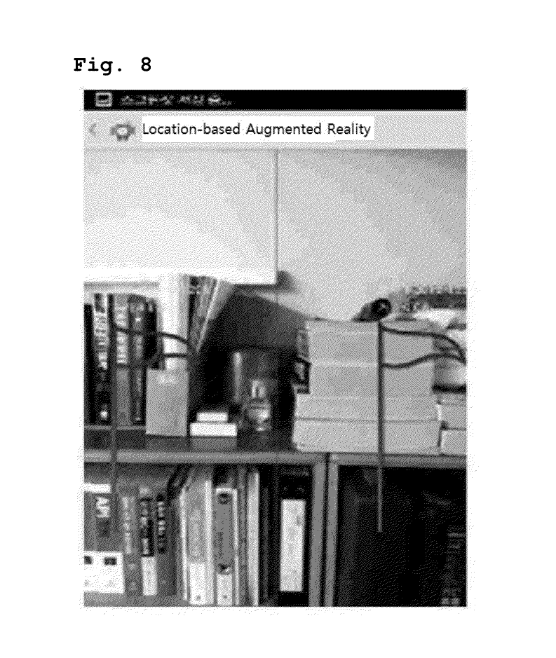

Furthermore, the position information for the facilities can be indicated on a map of the mobile device 10 as shown in FIG. 7 and can be shown in the form of location-based augmented reality as shown in FIG. 8.

Thus, a user can know the direction of the management target facility and the remaining distance to the management target facility through the use of the mobile device 10. Moreover, the user can confirm and manage the facilities on a real time basis and in the form of location-based augmented reality. The flags shown in FIGS. 7 and 8 indicate destinations to be found.

While one preferred embodiment of the invention has been described above, the present invention is not limited to the aforementioned embodiment. It is to be understood that various changes and modifications may be made without departing from the scope of the invention defined in the claims.

What is claimed is:

1. A location-based facility management system using a mobile device, comprising:
a database server configured to store object information on a management target facility acquired in advance as a database;
an image acquisition module configured to acquire an object image and GPS information;
an auto calibration module provided with an auto calibration algorithm which decides an internal parameter for the image;
a DB input/output module configured to store the object information in the database server and to receive the object information from the database server;
a position correction module provided with a position correction algorithm which corrects the GPS information of the object image using the internal parameter decided by the auto calibration module and the object information received from the DB input/output module; and
a mobile device provided with a facility management application which detects a characterizing point of an object image acquired by a camera after deciding an internal parameter of the object image and performs history management for the management target facility by matching the characterizing point with the object information stored in the database server.

2. The system of claim 1, wherein the database server is configured to store, as stored data, the object image of the management target facility, the object GPS information, and the basic object information including actual object measurement data and history data of the management target facility and is configured to store, as generated data, the information on the characterizing point of the object image detected by the facility management application of the mobile device.

3. The system of claim 1, wherein the facility management application is configured to match the characterizing point of the object image acquired by the camera of the mobile device with the characterizing point of the object image received from the database server and then to find the relative position of the mobile device with respect to the object using a stereo image method.
